(19) United States
(12) Patent Application Publication
(10) Pub. No.: US 2022/0241147 A1
(43) Pub. Date: Aug. 4, 2022

(54) METHOD OF CLEARING AN OBSTRUCTION IN A CHOKING PERSON

(71) Applicant: Puthalath Koroth Raghuprasad, Odessa, TX (US)

(72) Inventor: Puthalath Koroth Raghuprasad, Odessa, TX (US)

(21) Appl. No.: 17/162,372

(22) Filed: Jan. 29, 2021

(51) Int. Cl. A61H 31/00; A61H 23/06

(52) U.S. Cl. CPC A61H 31/00; A61H 23/06

(57) ABSTRACT

A simplified method of clearing a blockage caused by an obstruction in a person who is choking has the steps of standing the choking person behind a seat back of a chair, doubling the choking person over the seat back thereby having the choking person's head and chest pointing straight downwardly, and striking a back of the choking person repeatedly to drive the obstruction downwardly out of the throat towards the mouth of the choking person under the assistance of gravity to clear the obstruction. The method may further include the step of pressing the choking person's abdomen against the top of the seat back.

### TECHNICAL FIELD

The present invention is directed to methods to clear an obstruction in the throat or larynx (voicebox) of a person choking. The method is an improvement over current practices and allows gravity to assist in clearing the blockage.

### BACKGROUND OF THE INVENTION

While properly applied Heimlich procedures can save lives, the technique requires some expertise, strength and knowledge. Applying the procedure to overweight or obese people may be difficult.

The present invention avoids all those issues as well as taking advantage of locations such as restaurants or dining rooms where such accidents often take place where chairs are readily available.

The Heimlich maneuver or Abdominal Thrust is the most well-known technique and a first aid technique that is used to treat someone who has an upper airway obstruction from a foreign object, by removing the foreign object. This object cuts off air making it difficult or impossible for the person to breathe. Generally, in adults the foreign object is food, while in children it is often small objects. Some of the signs that someone has a blocked airway are the inability to talk, difficulty breathing or noisy breathing, squeaky sounds when breathing, and forced or weak coughing. A cardinal sign is the victim holding his/her neck with both hands, unable to speak, but displaying extreme distress and anguish. The American Heart Association technique on performing the Heimlich maneuver requires someone to apply the maneuver on another person choking. The technique is performed by standing behind the person, placing one foot slightly in front of the other, wrapping one's arms around the choking person's waist, tipping or leaning the person forward slightly, making a first with one hand, positioning it slightly above the choking person's naval, grasping that first with the other hand, then pressing hard into the abdomen with a quick, upward thrust as if trying to lift the choking person up. This can be repeated between six-10 times or until the blockage is dislodged.

Some experts suggest applying abrupt slaps on the back of the chest 5 times, followed by 5 attempts at Heimlich maneuver. There have been several other inventions without the assistance of another person to help in the process of conducting the Heimlich maneuver. Urso in U.S. Ser. No. 10/524,977(B1) describes Self-rescue anti choking implements. An anti-choking implement for compressing a choking victim's abdomen in order to expel lung gases thereby dislodging whatever causes the choking, the implement comprising: a thrust pad forming a pair of domed bilateral lobes, each dome having an open face that faces in a direction approximately parallel to that of the opposite dome; and at least one handle connected to said bilateral lobes for holding said bilateral lobes during bilateral compression of the choking victim's abdomen thereby causing rapid expulsion of air from the victim's lungs to dislodge whatever causes the choking. This allows the choking person to self-clear the obstruction without another's assistance.

Karpel, in U.S. Pat. No. 6,725,863(B2) discloses a “Choking assistance device to allow self clearing”. A choking assistance device, including a horizontally elongated head with a body-engaging surface used for compressing the upper abdomen of a choking victim and thereby expelling an object lodged in the choking victim's throat, said body-engaging surface having a horizontally elongated and vertically oblate central bulge extending forward of the remaining portions of said elongated head.

Ash, in U.S. Pat. No. 4,182,317(A1) discloses a method of using an object-dislodging apparatus of a dumbbell shape having oppositely disposed enlarged end portions by a victim in order to dislodge objects which are stuck in the victim's throat comprising the steps of: (a) placing one of said enlarged end portions of said apparatus against the abdomen of the victim at a location directly beneath the diaphragm; (b) clasping the hands over the other enlarged end portion of said apparatus and applying pressure against the abdomen by said one end portion; (c) orienting the apparatus so that it extends outwardly in a direction substantially perpendicular to the abdomen; (d) pulling inwardly with said clasped hands on the other enlarged end portion of the apparatus with a quick forceful thrust so as to cause a pulse wave of air to be sent up the throat and cause the stuck object to be dislodged. This device still requires another person to assist in the maneuver.

One of the main problems with the known method is often the choking person is too large for the person assisting or performing the Heimlich Maneuver to wrap their arms around the choking person. A large choking person often has a waist size larger than a small petite person can wrap their arms around, making the Heimlich maneuver difficult to perform.

### SUMMARY OF THE INVENTION

An improved method of clearing a blockage caused by an obstruction in a person who is choking has the steps of: standing the choking person behind a seat back of a chair, having the choking person bent over the seat back, folded in an inverted “U” shaped fashion, and striking the back of the choking person repeatedly to dislodge the obstruction downwardly out of a throat toward a mouth of the choking person under the assistance of gravity to clear the obstruction. The method may further include the step of: pressing the choking person's abdomen bent over the seat back against a top of the seat back.

Preferably, the step of striking or thumping the back of the choking person repeatedly is directed at the junction of the back of the neck and the upper part of the chest of the choking person to move the obstruction toward the mouth to clear the blockage. The step of repeatedly striking the back starts at a location near the root of the neck of the choking person. In this new procedure, the gravity aids the expulsion of the occluding chunk of food or perhaps even accomplishing the extrusion on its own, even before the thumping is done.

### BRIEF DESCRIPTION OF THE DRAWINGS

The invention will be described by way of example and with reference to the accompanying drawings in which:

FIG. 1 shows an exemplary chair having a seat and a seat back that can be used when practicing the method of the present invention.

FIG. 2 is a perspective view of a choking person standing and bent over the back of a chair back.

FIG. 3 is a side view of a choking person standing and bent over the back of a chair back. A variation of this procedure could be adapted by the victim by themselves by doubling over a seat back and using both the gravity and abrupt pressure on the abdomen to help expel the obstruction.

FIG. 4 is a view of a person striking the back of the choking person doubled over the chair back to drive the obstruction out of the throat toward the mouth out of the choking person aided by gravity.

FIG. 5 is a view of a person standing to the side of the choking person and striking the back of the choking person doubled over to drive the obstruction out of the throat toward the mouth out of the choking person aided by gravity.

FIG. 6 is a view of a person standing behind the choking person and striking the back of the choking person doubled over to drive the obstruction out of the throat toward the mouth out of the choking person aided by gravity and the support of the other hand supporting the abdomen of the choking person which constricts the abdominal area and increases the pressure.

### DETAILED DESCRIPTION OF THE INVENTION

The technique involves bending a choking person 2 over the back 14 of a chair 10, thus taking advantage of gravity. Then, displacing the obstruction in the larynx is accomplished by administering abrupt thumps at the top of the back of the chest, which can be facing the rescuer, but upside down. If such thumps are made in rapid succession, the obstruction will become loose and be expelled.

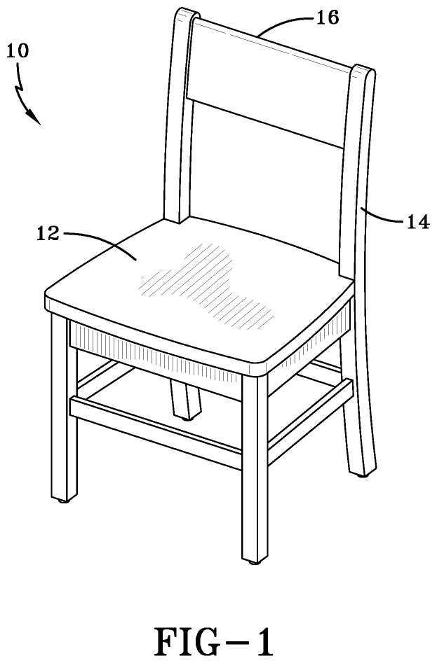

The method of clearing an obstruction of a choking person 2 is described hereinafter with illustrations showing FIGS. 1-5 to provide clarification as to how the method is to be practiced. With reference to FIG. 1, an exemplary chair 10 is illustrated, the chair 10 has a seat 12 and a seat back 14. These types of chairs are commonly found at restaurants and dining locations and generally do not include side arm rests, but could. The chair 10 is only provided as an exemplary example of one typical chair that could be used when practicing this method. The most important aspect of the chair 10 is that it has a seat back 14. The seat back 14 includes a top portion 16 which can be useful when practicing the present invention.

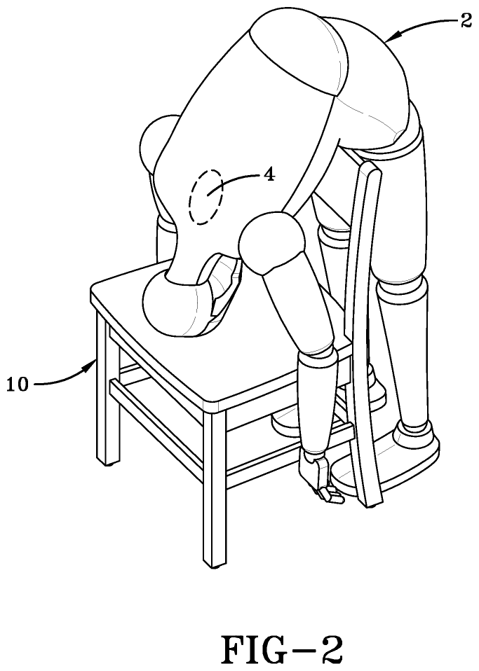

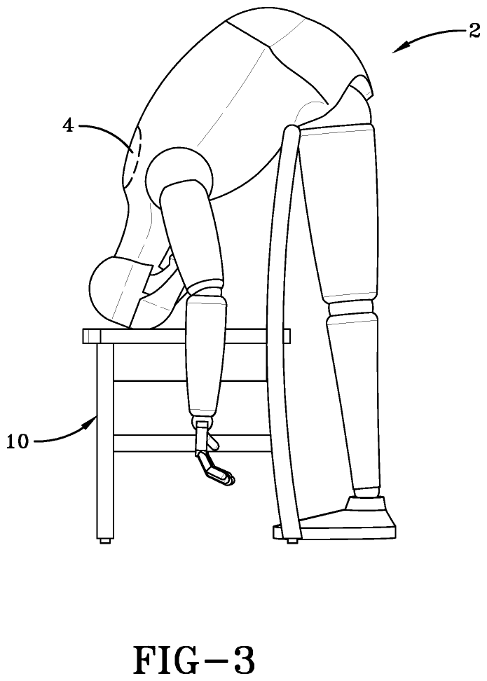

With reference to FIGS. 2 and 3, when a person 2 is choking, the present method is shown rather than the more conventional Heimlich maneuver which requires the person assisting to wrap arms around the choking person, make a first and try to drive the obstruction upward as if trying to lift the victim while standing behind the choking person. It is common knowledge that this is often difficult to achieve particularly by people 20 who are petite or small or when the choking person 2 is extremely large.

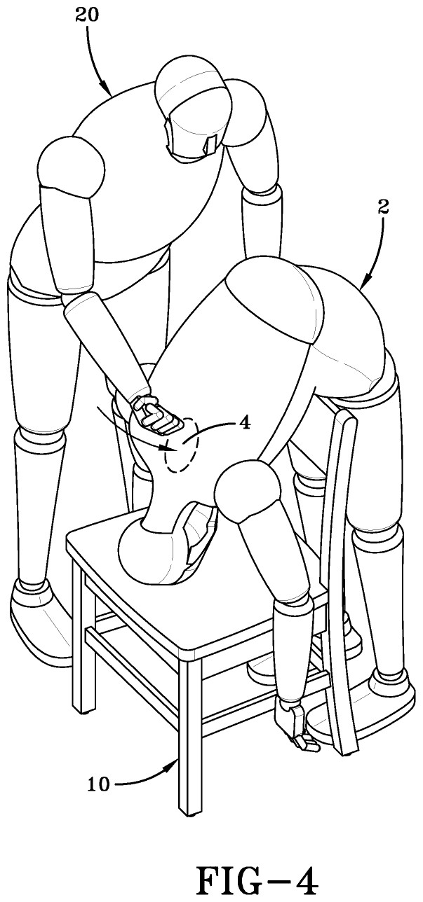

The present invention is an improvement over the current prior practice. In the present invention, the choking person 2 is standing behind the chair 10 and is bent over the top 16 of the seat back 14 as illustrated. In the illustrations, the choking person's arms are shown hanging vertically downward. Alternatively, the choking person could hold the back portion of the seat back 14 or the choking person 2 could put his hands forward if desirable and use the seat 12 as a means of stabilizing themselves. In any event, the objective is to place the choking person's 2 abdomen across the top 16 of the seat back 14 as shown in FIGS. 2-4. When this is accomplished, it creates significant pressure in the region, once this is achieved, the rescuer or person assisting 20 can stand either beside the choking person 2 or in front of the choking person 2 such that the back 4 of the choking person 2 is visible or available to the rescuer 20 so that the rescuer 20 can provide striking force against the choking person's 2 back 4 preferably at the root of the neck or junction of neck and chest in a repeating fashion, as shown in FIG. 4. This can be done with a closed fist, the fleshy outer part next to the little finger providing a force to help drive the obstruction with the assistance of gravity out of the choking person's larynx so that it can expel the obstruction from the throat, thereby clearing the obstruction and allowing the choking person 2 to breathe. It is believed that this is a preferred way of removing an obstruction with the use of a common article such as a chair 10 with a seat back 14.

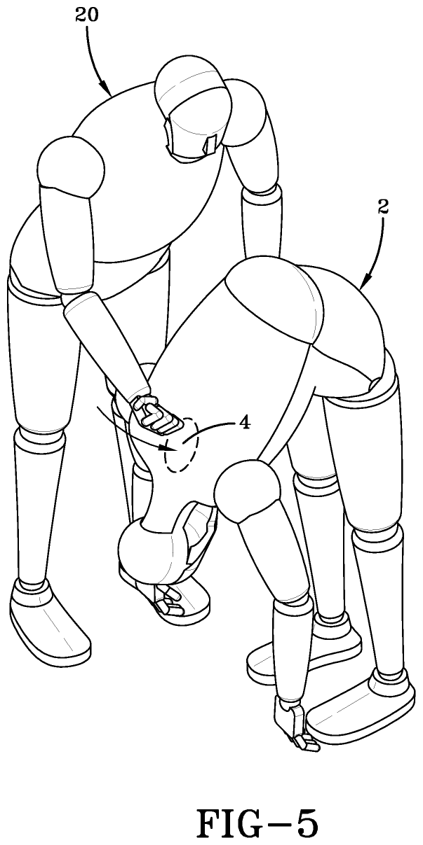

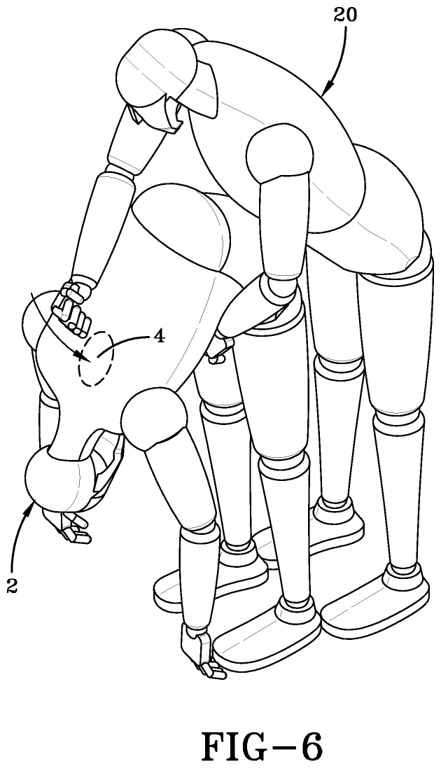

An alternative method of removing an obstruction from a choking person 2 is illustrated in FIGS. 5 and 6. The choking person 2 is doubled over similar to the previous method only without the aid of a chair 10. The rescuer 20 is shown standing to the side of the choking person 2 striking the area 4 below the neck in FIG. 5. Alternatively, the rescuer 20 is shown standing behind the choking person 2 striking the area 4 below the neck to dislodge an obstruction with the aid of gravity and the support of the other hand supporting the abdomen of the choking person which constricts the abdominal area and increases the pressure.

In summary, the present invention method is easier to perform and possibly more effective than the established Heimlich maneuver. First, doubling the victim over uses gravity more efficiently to expel the obstructing foreign body. The proximal part of larynx is wider than the distal, where the vocal cords present a distinct constriction, and thus the dangerous obstruction. Second, the use of a chair back to press onto the abdomen uses the person's own weight to increase intra-abdominal pressure to further aid in the dislodging of the offending food bolts or obstruction. Third, the delivery of repeated thumps at the root of the neck/junction of neck and chest, leads to more effective shaking loose of the obstructing bolts or chunk of meat. Also, this technique can be performed by a person of any size, while standing behind, in front of or even more effectively from the side of the victim. Additionally, the victim themself can perform this technique, except self-thumping will be impossible. Finally, if a chair back is not available, simply doubling the victim over can often accomplish the job of dislodging any obstruction as shown in FIGS. 5 and 6. This version is especially suited for pregnant women in their later stages of pregnancy. Similarly, the technique can be adopted in babies by simply holding them upside down, by grabbing the feet and then thumping at the right location as mentioned earlier.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is therefore, to be understood that changes can be made in the particular embodiments described, which will be within the full intended scope of the invention as defined by the following appended claims.

What is claimed is:

1. An improved method of clearing a blockage caused by an obstruction in a person who is choking comprises the steps of:
standing the choking person behind a seat back of a chair;
doubling the choking person over the seat back thereby having the choking person's head and chest pointing vertically downward; and
striking a back of the choking person repeatedly to drive the obstruction downwardly out of a throat toward a mouth of the choking person under the assistance of gravity to clear the obstruction.

2. The method of claim 1 further comprises the step of:
pressing the choking person and leaning over the seat back against a top of the seat back, which accentuates the effect gravity has in dislodging the obstruction.

3. The method of claim 1 wherein the step of striking the back of the choking person repeatedly is directed at the junction of the back of the neck and the upper part of the chest of the choking person toward the head of the choking person to move the obstruction toward the head to clear the blockage.

4. An improved method of clearing a blockage caused by an obstruction in a person who is choking comprises the steps of:
doubling the choking person over, thereby having the choking person's head and chest pointing vertically downward; and
striking a back of the choking person repeatedly to drive the obstruction downwardly out of a throat toward a mouth of the choking person under the assistance of gravity to clear the obstruction.
